(19) United States
(12) Patent Application Publication
(10) Pub. No.: US 2006/0051491 A1
(43) Pub. Date: Mar. 9, 2006

(54) Protein beverage mixing container

(76) Inventor: Kenneth E. Levitt, Independence, MN (US)

Correspondence Address: Kenneth E. Levitt, 3050 Becker Road, Independence, MN, 55359, US

(21) Appl. No.: 10/933,615

(22) Filed: Sep. 3, 2004

(51) Int. Cl. A23J 1/00

(52) U.S. Cl. 426/656

(57) ABSTRACT

The present invention is a protein beverage mixing container. The mixing container may be a carton, or it may be a pouch. The mixing container has a closeable opening. The mixing container contains dry protein powder, or a user may add protein powder into the mixing container. A user then may add liquid into the mixing container, mix the protein and liquid, and consume the mixture.

### FIELD OF THE INVENTION

The invention relates to the field of beverage mixing containers. The invention relates more specifically to portable, disposable beverage mixing containers containing a protein source. Liquid can be added to the container to prepare a convenient protein supplement.

### BACKGROUND OF THE INVENTION

Protein consumption is crucial for physically active individuals, such as athletes. Individuals who engage in intense physical activity, including football and bodybuilding, require significant amounts of protein for muscle growth and repair. It is common to consume 1 to 2 grams of protein per pound of bodyweight, sometimes more, depending on the individual's needs.

The human body does not store protein other than in muscle tissue. In addition, the body typically cannot absorb more than 30 to 35 grams of protein in a given serving, though single serving sizes of 60 grams and higher are used, and 40 to 50 gram servings are common. Accordingly, physically active individuals require intake of many single servings of protein throughout the day. Physically active individuals typically require protein intake every two to four hours, sometimes hourly in smaller servings, in order to meet their daily protein requirements. Because the bodies of physically active individuals are repairing and rebuilding muscle tissue for hours and days after strenuous exertion, it is important for physically active individuals not to go longer than four hours during the day without protein intake. Many physically active individuals also consume a serving of protein during the middle of the night, depending on their needs.

It is difficult for a physically active individual to consume the necessary amounts of protein from meals alone. This is because many whole foods are not sufficiently high in protein without also containing too much fat or too many carbohydrates. In addition, consuming enough whole food to provide sufficient protein is difficult, not only because it requires consumption of substantial quantities of whole food, but also because it can require preparation of several meals each day. This is quite inconvenient. Accordingly, protein supplements, typically in the form of powders or powders that have been premixed into liquids, are used. Physically active individuals often will consume several servings of a protein supplement each day. The use of protein supplements is particularly important for vegetarian athletes.

With the aid of protein supplements, a physically active individual who has access to a kitchen or other suitable facility can consume the required amounts of protein each day. However, for those individuals who travel, or are away from home for several hours or days, maintaining the required amount of protein intake can be quite difficult. Carrying protein powder and containers for mixing the powder with liquid can be done for very limited numbers of servings, but it is messy, inconvenient, and not practical for larger numbers of protein servings, such as would be required when the individual is away from home for several hours or more or is traveling.

Premixed, ready-to-drink protein supplement beverages are commercially available. EAS offers a Nutrition Shake, which has from 25 to 40 grams of protein, enough for a single serving. Each of these containers alone is from about 11 to about 17 fluid ounces. American Bodybuilding, Inc., provides containers of premixed protein drinks that range generally from 18 to 24 fluid ounces in size with from 25 to 50 grams of protein. A physically active individual who will be away from home for several hours or more, or who is traveling, would have to carry many of these ready-to-drink beverage containers to meet the individual's protein needs. Because these ready-to-drink containers are both bulky and heavy, carrying them is not a practical solution for protein intake for an individual who will be out for several hours or who is traveling.

Various types of protein bars and snacks also are available. These products, however, typically contain other ingredients, including sugars and carbohydrates, that physically active individuals prefer to avoid, particularly where a significant amount of these products would have to be consumed to meet a physically active individual's protein requirements.

Other individuals who are not necessarily engaged in strenuous physical activities also may have high protein needs. These individuals may have high protein intake for dietary, weight loss, or other reasons. These individuals face the same problems that are discussed above for physically active individuals.

A need remains for a convenient, lightweight source of protein for physically active individuals and others who require a significant amount of high quality protein while they are away from home.

### BRIEF SUMMARY OF THE INVENTION

The present invention, in one embodiment, involves a mixing container that contains a protein source. Before use, the user (physically active individuals and others) adds liquid to the mixing container and mixes the protein source into the liquid. The user then can consume the contents of the mixing container.

The mixing container of the present invention has a body and an opening. The body is any suitable vessel. The mixing container's opening preferably can be closed, because a user more easily can shake or otherwise mix the protein source and liquid if the mixing container can be closed. The mixing container preferably is disposable or recyclable after a single use, though in some embodiments of the invention the mixing container is reused. In some embodiments, the body of the present invention can be an open vessel, in which case the protein source and liquid can be mixed by stirring or other suitable means. The body of the present invention's mixing container can be flexible, as with a milk carton or juice pouch; semiflexible, as with a plastic soda bottle; or rigid. The flexible body is preferred because it can be compressed generally flat, and is easier to store and transport. Preferably, lightweight materials are used for the mixing container. In one embodiment, the mixing container is lightweight and disposable to enhance portability.

In one embodiment of the present invention, the body is a pouch. The pouch is a flexible bag made by sealing two sheets of material together around their edges. Those skilled in the art recognize that pouches can be any suitable material, including polyethylene, polypropylene, nylon, or polyester, and that they can be made in a variety of shapes. U.S. Pat. Nos. 6,485,177; 6,077,208; 6,076,968; 5,188,261; and 4,898,477 describe materials, laminates, and configurations for pouches. Each of these patents, along with the other patents cited herein, are incorporated by reference.

In another embodiment of the present invention, the body is a carton made of any suitable material, including plastic or a composite laminate that includes paper or card stock. Cartons for holding liquid food products are known in the art. The paper or card stock can be made water impermeable with various coatings or protective layers, including wax, plastic, films, or foil. The structure of such carton bodies is described in U.S. Pat. Nos. 6,576,304; 5,714,217; 4,977,004; 4,806,398; 4,789,575; and 4,701,360. The carton may be manufactured from a tubular web of the material. In one embodiment, the carton is creased during the manufacturing process so that the user easily may change the carton's shape from flat into a parallelepiped or the desired polyhedron, such as a hexahedron, prior to adding fluid into the mixing container. The configuration and geometry of the carton container is known in the art, as shown in the above patents and in U.S. Pat. Nos. 6,746,388; 6,371,646; 5,788,121; 5,156,295; and 3,119,548.

In other embodiments of the present invention, the body of the mixing container may be any suitable shape, including bottle, bag, or any other desired shape. Both the selection of materials and the selection of shape for the mixing container's body can be made by those of ordinary skill in the art.

The mixing container's opening can be closeable by any of a variety of means. In one embodiment, the opening is a circular spout with threads on the outside, and it has a screw-on cap with complementary threads on its inside, where the cap's diameter is larger than the spout's diameter. These openings are routinely used for containers for orange juice and other liquids that require mixing. Examples are set forth in U.S. Pat. Nos. 5,379,910; 5,255,813; 5,125,886; 4,909,434; and 4,669,640.

In another embodiment, the opening is a circular spout with threads on its inside. The opening can be closed with a complementary cap with threads on its outside, where the diameter of the cap is smaller than the diameter of the spout. Alternatively, the spout can be sized and threaded to accommodate any given brand of water bottle, so that the bottle can be screwed into the mixing container, whether by squeezing or otherwise. The spout also can be sized to accommodate a container, such as a complementary branded bottle, that has a vent to allow easy transfer of its liquid into the mixing container of the present invention. The mixing container itself also can have a vent to allow easy introduction of liquid into the mixing container. The vent can be closable by any suitable means to allow for mixing. The spout also can accommodate a threaded connector or funnel to facilitate liquid being added to the mixing container.

In other embodiments, the opening is closeable with a plug, pressure fitment, snap-on lid, or tape seal. The closeable opening may be generally flat, such as with a hinged lid, so that the mixing container may be folded or stacked more easily. A closeable opening may be closed by any means that permit the user to mix the liquid into the protein. The opening is sized sufficiently large to allow easy introduction of liquid into mixing container's body. The opening also may be sized to allow the user to add ingredients, such as glutamine, creatine, or additional protein. In another embodiment, the opening allows the introduction of liquid or additional ingredients through a provided adaptor or through a generally available one, such as a funnel. In one embodiment, an adaptor, such as a plastic, paper, or laminate funnel that has been folded flat, may be provided with the mixing container, such as by removably affixing it to the outside of the container.

In a preferred embodiment, the mixing container's opening is sealed prior to providing the product to the user. This protects the safety, quality, and integrity of the product and the protein source until the opening is opened by the user, after which it may be closed as described above. The opening can be sealed in any suitable manner, including with a frangible membrane or a piece that can be removed with a pull-tab.

In some embodiments, the mixing container's body or a panel, portion, or strip of the mixing container's body is translucent or transparent so that the user can see how much liquid has been added to the mixing container. For example, one layer of the mixing container can have a small opening made in it, while another layer (such as an impermeable plastic) does not and is joined to the layer with the opening.

In one embodiment, one or more mixing devices are located inside the mixing container's body to facilitate mixing. Such mixing devices can include a mesh shape, such as a mesh ball; solid shapes; or any other suitable shape. The mixing devices preferably are larger than the opening so that the user does not ingest them. Alternatively, the mixing devices can be smaller than the opening, and a screen or other porous layer can be used in the opening to prevent the user from ingesting the mixing device.

The liquid for use with the present invention can be water, juice, milk, or any suitable liquid. Water is preferred, because of its general availability and because it does not contain sugars, as are present in substantial quantities in milk and juice. The water can be from a water bottle, drinking fountain, tap, or any other potable water source.

The protein source for use with the present invention can supply any suitable protein. Suitable proteins include whey isolate, whey concentrate, soy isolate, casein, egg powder, and mixtures of these. Other suitable protein sources also may be used with the invention. The protein itself may be provided in various forms. In one embodiment, the protein may be provided in powder form. The protein also may be in a suitable gel or paste form, or in suspension or solution, in which case the appropriate sterilization and packaging steps should be followed. One benefit of providing the protein in a concentrated gel or paste form is to avoid clumps and aid in even distribution of the protein in the liquid. Various modifications can be made to the protein, including making it into a shake formulation; adding additional ingredients such as vitamins, glutamine, or creatine; or adding flavorings, colorings, or mixing agents such as emulsifiers. Many protein drinks presently are commercially available, and one of ordinary skill in the art can provide a suitable formulation for any given application. The choice of protein source can be a function of the needs of the users of the product, and of the shape of a given container. Choice of a suitable protein type and form can be made by one of ordinary skill in the art. One preferred embodiment for the present invention is whey protein concentrate in powder form. Another preferred embodiment is whey protein isolate, also in powder form. While the various embodiments of the present invention are described primarily for use with protein, those of skill in the art will recognize that it can be used for many beverages and for other applications.

The protein source, in one embodiment, is prepackaged inside the mixing container, and the mixing container is then closed. For example, dry protein powder can be added to the container by the manufacturer or distributor, prior to the mixing container being made available to the user.

The protein source also can be supplied in a source external to the mixing container. The protein can be supplied in quantities larger than one serving, including bulk quantities, for introduction into the mixing container. In another embodiment, the protein can be supplied in single-use servings for introduction into and mixing in the mixing container. Any suitable packaging that allows the protein to be poured or extruded into the mixing container will suffice. The packaging for the single use servings can be in the form of a generally flat packet that is removably attached to the mixing container.

The protein source may be supplied in multiple serving sizes, or in a single serving size. Any desired quantity of protein can be used as the protein source. In one embodiment, the protein serving is provided in a single serving size, anywhere between about 5 and about 60 grams, or between 20 and 50 grams.

The mixing container itself can be any suitable size. The mixing container size is in part a function of the amount of protein to be consumed, the type of liquid carrier, and the desired concentration of protein in the drink. While any palatable ratio may be used, in one embodiment, 25 grams of protein is provided in 12 ounces of liquid, while in another embodiment, 40 grams of protein may be provided in 16 ounces of liquid.

Any suitable size mixing container may be used. The mixing container can be the size of the desired drink, or the mixing container can be larger than the desired drink, such as to allow room for mixing or shaking. In one embodiment, 25 grams of protein is provided for a 12 ounce mixing container. The user can empty a 12 ounce bottle into the 12 ounce mixing container, close the mixing container, mix the protein and water by shaking or stirring, and consume the protein. In another embodiment, 25 grams of protein for a 12 ounce drink is provided in a 15 ounce mixing container. The user empties a 12 ounce water bottle into the mixing container, and the empty space in the mixing container can facilitate mixing by shaking. Where the mixing container is made larger than the intended serving size, this can be done by simply making the mixing container so that its size will be larger than the-serving size. If the mixing container is a hexahedron, it can be sized larger than the amount of liquid to be added. Alternatively, a gable top can be added to the top to allow extra room for mixing. In yet another embodiment, a mesh screen or other filter is provided across the center of the mixing container to aid in mixing. The user can mix the protein in to the liquid by filling the container with liquid and then mixing by any suitable means, including shaking or stirring. The user also can fill the container partially with liquid, mix the liquid and protein, and then mix in more liquid, after which the user can consume the mixture.

### BRIEF DESCRIPTION OF THE DRAWINGS

FIG. 1 is a bottom isometric view of the pouch embodiment of the present invention, with part of the mixing container broken away.

FIG. 2 is a top isometric view of the carton embodiment of the present invention in its popped up state.

FIG. 3 is a top isometric view of the carton embodiment of the present invention in a partially folded state.

FIG. 4 is a top isometric view of the carton embodiment of the present invention in its generally flattened state.

FIG. 5 is a top isometric view of an opening for the mixing container with external threads and its complementary cap.

FIG. 6 is a top isometric view of an opening for the mixing container with internal threads and its complementary cap.

FIG. 7 is a top isometric view of a generally spherical mixing device embodiment of the present invention.

FIG. 8 is a top isometric view of a generally cube mixing device embodiment of the present invention.

FIG. 9 is a top isometric view of a generally triangular mixing device embodiment of the present invention.

FIG. 10 is a side plan view of the carton embodiment, in a partially folded state, that also shows the mesh layer embodiment.

FIG. 11 is a side plan view of the carton embodiment, in its fully folded state, that also shows the mesh layer embodiment.

FIG. 12 is a cross-sectional view taken along line 12-12 of FIG. 11, showing the mesh layer embodiment of the present invention is a bottom isometric view of the pouch embodiment of the present invention.

### DETAILED DESCRIPTION

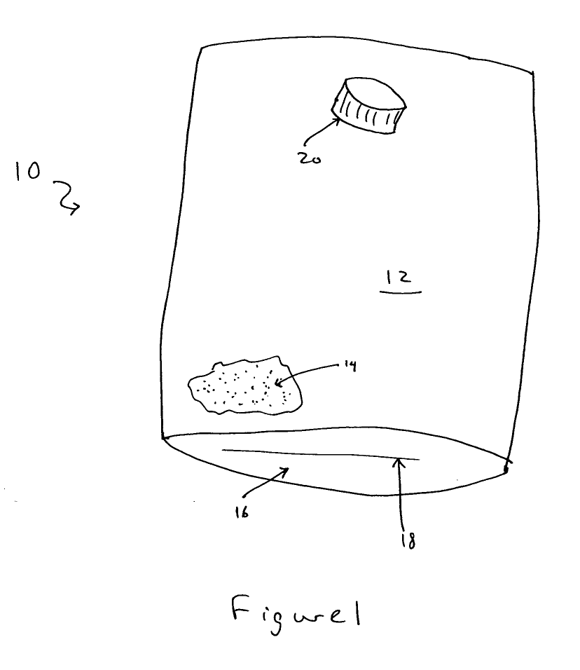

FIG. 1 depicts one embodiment of the present invention 10. In this embodiment, a pouch 12 is shown. The pouch 12 has dry protein powder 14 inside it, as shown in the broken away portion. The pouch 12 may be folded so that it has a bottom 16, which may have a crease 18. Pouch 12 is shown with an opening 20, which is a spout with external threads that is covered by a complementary cap with matching internal threads. The pouch 12 may be made by known methods, including running a moving web, such as a tubular web, down a production line and adding dry protein powder 14 into the pouch. Known registration technology may be used in the production. To use pouch 12, a user opens opening 20 and introduces the desired amount of liquid. The user then closes opening 20, and mixes the liquid into the dry protein powder 14, such as by shaking or squeezing the pouch 12. The user then opens opening 20 and may consume the contents of pouch 12. The pouch 12 also can take the form of a round bag, a bottle of any desired level of flexibility, or any other suitable shape.

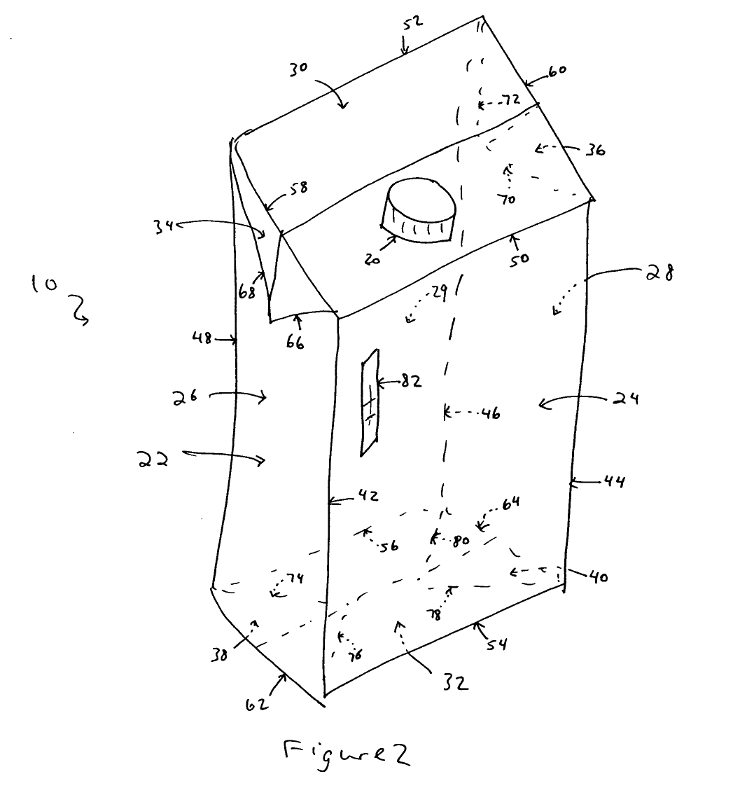

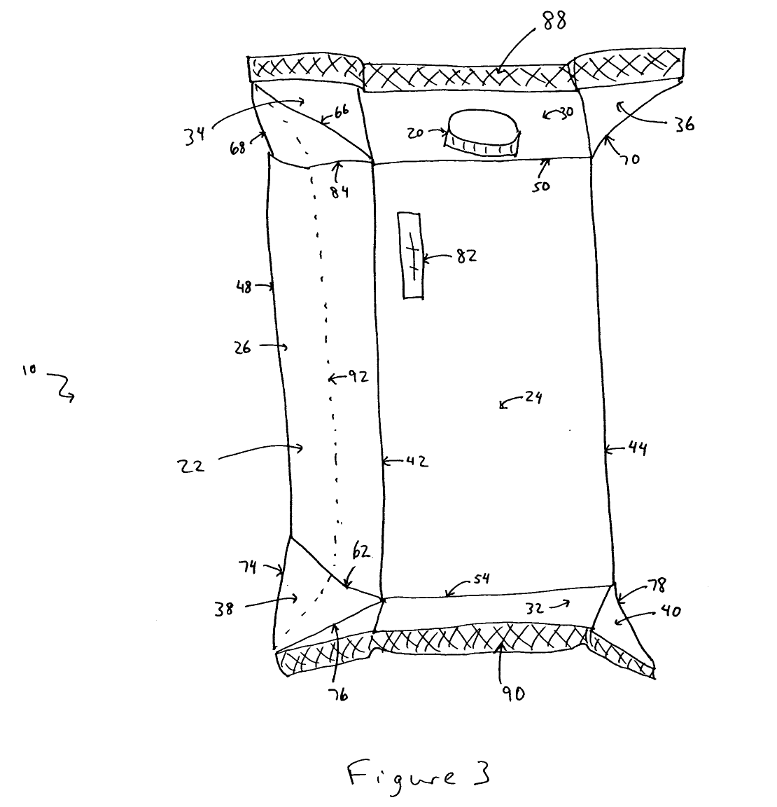

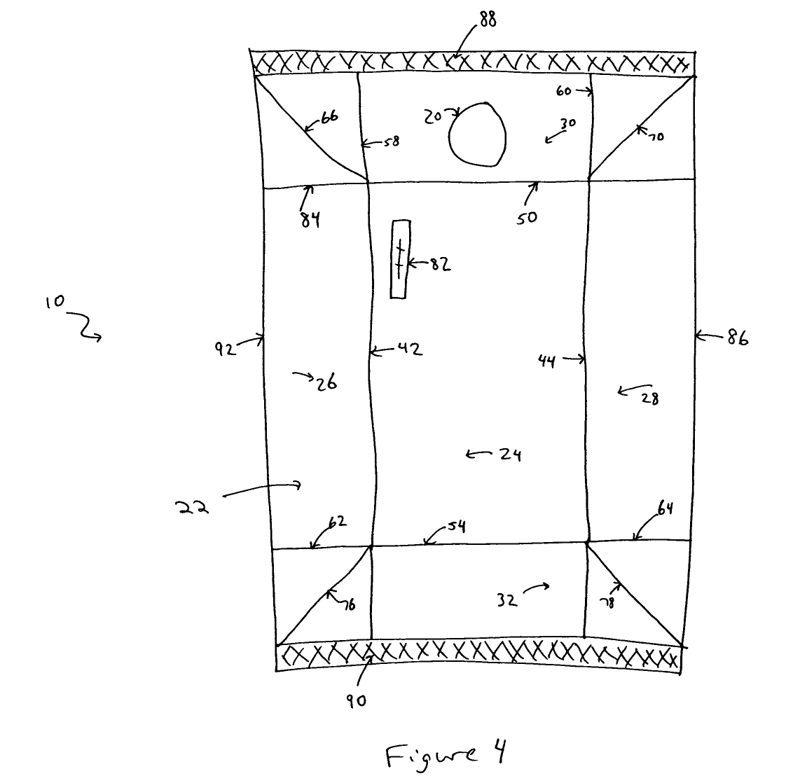

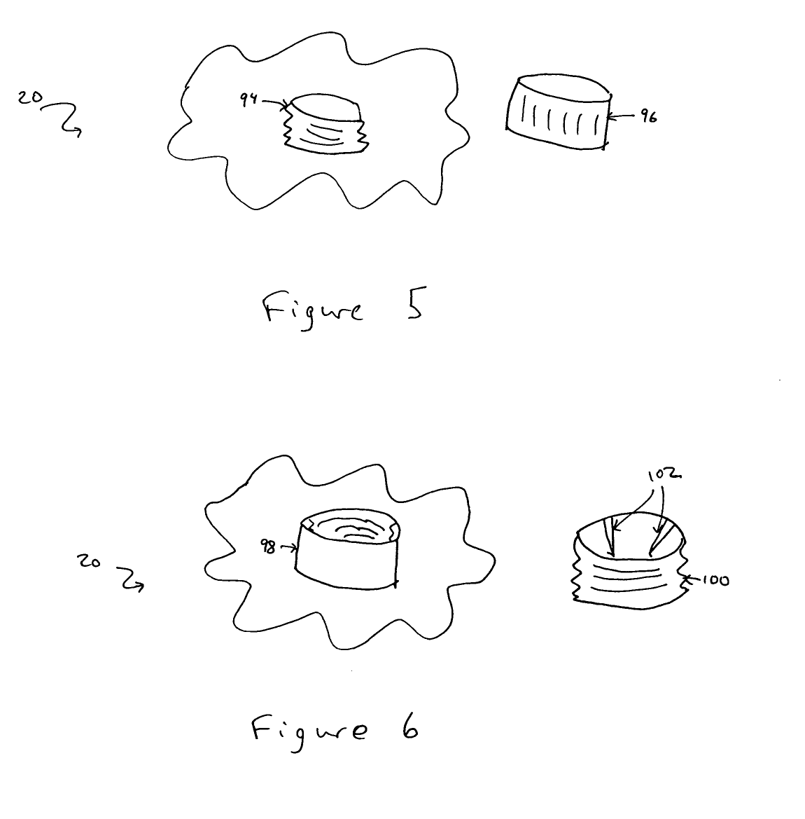

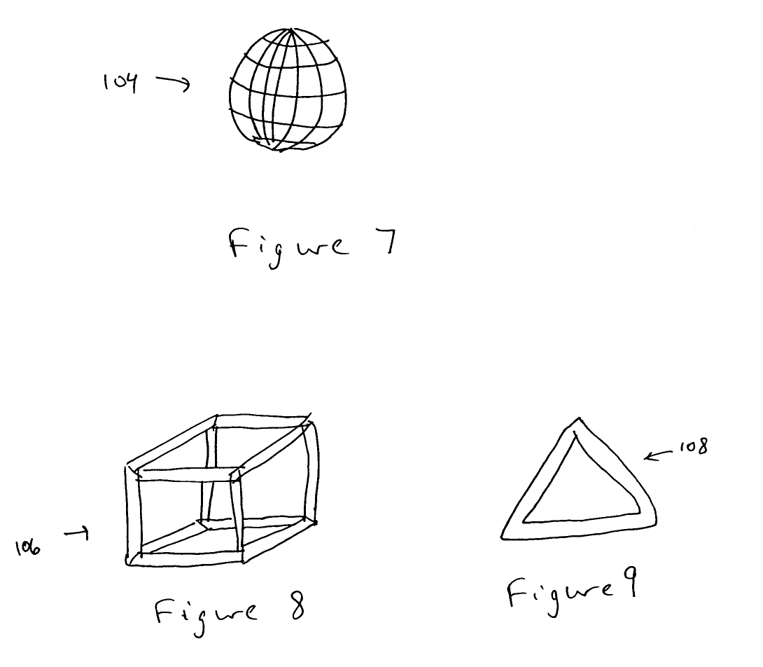

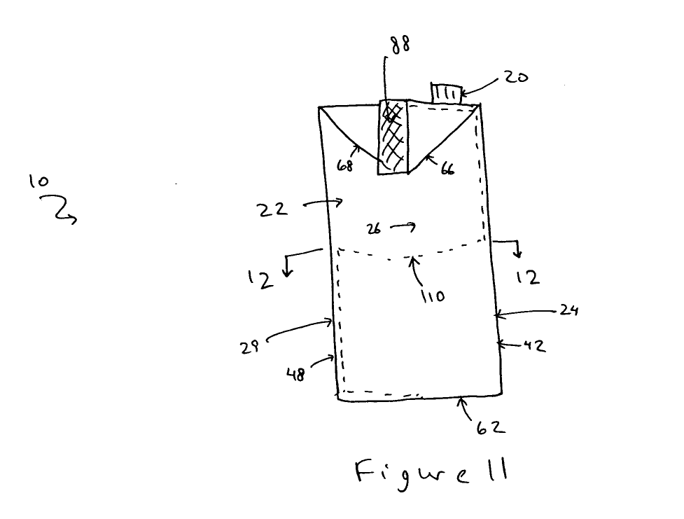

FIG. 2 depicts another embodiment of the present invention 10. In this embodiment, the mixing container is a carton 22 that is known in the art. Carton 22 may be provided to the user in a generally flattened state, and then popped up by the user. In its popped up state, as shown in FIG. 2, the carton 22 has a front face 24, a left side 26, a right side 28, and a back side 29. The carton also has a top 30 and a bottom 32, which are formed by folding the carton from its flat state (described in connection with FIGS. 3 and 10). In the folding process, top ears 34 and 36 are formed, as are bottom ears 38 and 40. As depicted, top ears 34 and 36 are folded down, to the side, while bottom ears 38 and 40 are folded in, under the carton 22. The carton 22 is folded along a series of creases 42, 44, 46, 48, 50, 52, 54, 56, 58, 60, 62, 64, 66, 68, 70, 72, 74, 76, 78, and 80, some or all of which may be introduced during the manufacturing process. The carton 22 also contains an opening 20, as shown in FIG. 1. In one embodiment, carton 22 may contain a window 82, which is made of a transparent or translucent material. Window 82 allows the user easily to see when the liquid level in the carton 22 has reached a desired level. Window 82 may be provided with indicia to indicate to the user what the liquid level in carton 22 is.

FIG. 3 depicts the carton 22 of FIG. 2 in a state that is between the generally flattened state and the popped up state shown in FIG. 2. Like numbers in FIGS. 2, 3, and 4 indicate the same elements in each of the figures. In addition, FIG. 3 shows additional crease 84. The carton 22 is formed from a tube, and has a top seam 88 and a bottom seam 90.

FIG. 4 depicts a top plan view of carton 22 of FIGS. 2 and 3 in its generally flat state. In its generally flat state, the carton 22 is folded at its top seam 88, its bottom seam 90, its left fold 92, and an opposite fold 86, and it is bent only slightly or not at all at the creases 42, 44, 46, 48, 50, 52, 54, 56, 58, 60, 62, 64, 66, 68, 70, 72, 74, 76, 78, 80, and 84. It is recognized that, when carton 22 has dry protein powder 14 in it, it is not completely flat when in its generally flattened state

To use the embodiment of the present invention 10 as depicted in FIGS. 2, 3, and 4, the user may acquire the carton 22 in its popped up state, as shown in FIG. 2, or its generally flattened state, as shown in FIG. 4. If the user acquires the present invention 10 in its generally flattened state, the carton 22 is easily popped up by applying pressure at left fold 92 and right fold 86, and then folding the ears 34, 36, 38, and 40 back as desired. The carton 22 may, in one embodiment, be provided by the user with dry protein powder 14 (not shown) already inside it. Alternatively, the user may add the dry protein powder 14 into the carton 22, either from a provided single serving pouch (not shown) or other source. The user then adds the desired amount of liquid to the carton 22, mixes the protein and liquid, as by shaking, and consumes the contents of the carton 22. If the carton 22 is disposable, the user may place it any suitable receptacle.

FIG. 5 depicts an opening 20 that is closeable and suitable for use in the present invention 10. The opening is a circular spout 94 with threads on the outside. A complementary cap 96 has threads on its inside surface that are configured to engage the threads on spout 94.

FIG. 6 depicts an alternative embodiment of a closeable opening 20. The opening also is a circular spout 98, but it has threads on its inner surface. Its complementary cap 100 has threads on its outer surface that are configured to engage the threads on spout 98. The inside of cap 100 may be provided with fins 102 to help the user turn the cap 100.

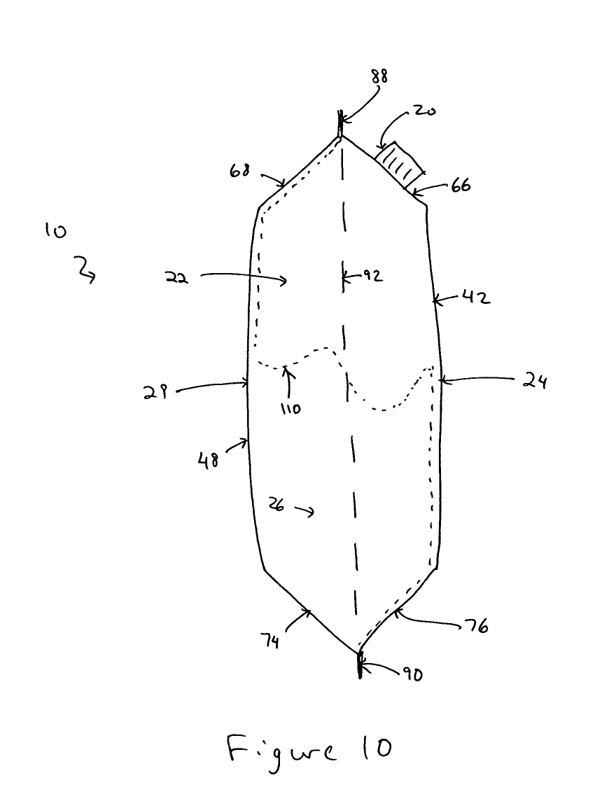

FIG. 7 depicts a generally spherical mixing device 104 that can be placed in the mixing container of the present invention. Mixing device 104 also may be provided in a flatter form (not shown). FIG. 8 depicts a cube shaped mixing device 106. FIG. 9 depicts a triangular shaped mixing device 108. Any of these mixing devices 104, 106, or 108 can be placed into the mixing container of the present invention to help strain and break up clumps of dry protein powder. Preferably, the mixing devices 104, 106, and 108 are larger than the mixing container's opening. They may be made of any suitable flexible material, so that they can be forced through the opening if desired. Many other configurations for mixing devices are suitable for use in the present invention.

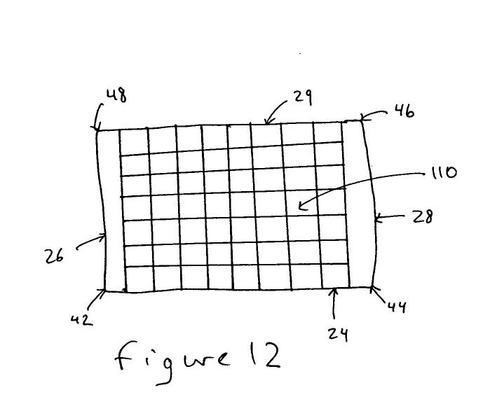

FIGS. 10 shows a side plan view of the carton 22 of FIG. 3. FIG. 11 shows a side plan view of the carton 22 in its fully folded, or popped up, state. The embodiment in FIGS. 10 and 11 also contains a mesh screen 110. The length of the mesh screen 110 is at least as long as the length of the left fold 92 and right fold 86. As can be seen, the mesh screen is attached to the inner surface of the back side 29 of the carton 22 and to the inner surface of the front face 24 of the carton 22. As is best seen in FIG. 12, the mesh screen 110 is narrower then the width of the carton 22. When the carton 22 is in its generally flattened state, the mesh screen is sandwiched between the front face 24 and back side 29 of the carton 22. When the carton 22 is folded, the mesh screen 110 extends between the front face 24 and back side 29 of the carton 22, across the interior of the carton 22. The mesh screen 110 aids in mixing the dry protein powder 14 into the liquid inside the mixing container. Any suitable configuration of mesh screen 110 can be used.

Although the present invention has been described with reference to preferred embodiments, persons skilled in the art will recognize that changes may be made in form and detail without departing from the spirit and scope of the invention.

I claim:

1. A protein beverage mixing container, comprising:
a disposable carton;
a closeable opening in said carton; and
at least about 10 grams of dry protein powder prepackaged within said carton.

2. The protein beverage mixing container of claim 1, wherein said dry protein powder comprises whey protein powder.

3. The protein beverage mixing container of claim 2, wherein said carton contains at least about 20 grams of whey protein powder.

4. The protein beverage mixing container of claim 2, wherein said carton contains at least about 30 grams of whey protein powder.

5. The protein beverage mixing container of claim 2, wherein said carton contains at least about 40 grams of whey protein powder.

6. A method of supplementing protein intake, comprising the steps of:
acquiring a disposable protein beverage mixing container comprising a carton, wherein said carton comprises a closeable opening and at least about 10 grams of dry protein powder prepackaged inside said carton;
adding liquid into said carton;
mixing the liquid and the protein powder in said carton; and
consuming the mixture of liquid and protein.

7. The method of claim 6, wherein said dry protein powder comprises whey protein powder.

8. The method of claim 7, wherein said carton contains at least about 20 grams of whey protein powder.

9. The method of claim 7, wherein said carton contains at least about 30 grams of whey protein powder.

10. The method of claim 7, wherein said carton contains at least about 40 grams of whey protein powder.

11. A protein beverage mixing container, comprising:
a disposable mixing container;
a closeable opening in said mixing container; and
at least about 10 grams of dry protein powder prepackaged within said mixing container.

12. The protein beverage mixing container of claim 11, wherein said dry protein powder comprises whey protein powder.

13. The protein beverage mixing container of claim 12, wherein said mixing container contains at least about 20 grams of whey protein powder.

14. The protein beverage mixing container of claim 12, wherein said mixing container contains at least about 30 grams of whey protein powder.

15. The protein beverage mixing container of claim 12, wherein said mixing container contains at least about 40 grams of whey protein powder.

16. A method of supplementing protein intake, comprising the steps of:
acquiring a disposable protein beverage mixing container, wherein said mixing container comprises a closeable opening and at least about 10 grams of dry protein powder prepackaged inside said mixing container;
adding liquid into said mixing container;
mixing the liquid and the protein powder in said mixing container;
and consuming the mixture of liquid and protein.

17. The method of claim 16, wherein said dry protein powder comprises whey protein powder.

18. The method of claim 17, wherein said mixing container contains at least about 20 grams of whey protein powder.

19. The method of claim 17, wherein said mixing container contains at least about 30 grams of whey protein powder.

20. The method of claim 17, wherein said mixing container contains at least about 40 grams of whey protein powder.
